(19) United States
(12) Patent Application Publication
(10) Pub. No.: US 2009/0012802 A1
(43) Pub. Date: Jan. 8, 2009

(54) Parcel retrieval system and method

(76) Inventor: Roy Pinney, Fort Lauderdale, FL (US)

Correspondence Address: LERNER GREENBERG STEMER LLP, P O BOX 2480, HOLLYWOOD, FL, 33022-2480, US

(21) Appl. No.: 11/824,976

(22) Filed: Jul. 3, 2007

(51) Int. Cl. G06Q 10/00

(52) U.S. Cl. 705/1

(57) ABSTRACT

A parcel retrieval system and method are provided. If the intended recipient receives notice of a failed delivery attempt of a parcel by a delivery driver, the recipient may be put in contact with the delivery service via voice telephone communications, or via an internet website or the like. The delivery vehicle provides the delivery service with position information regarding the current location of the delivery vehicle. The delivery service utilizes the current position information provided by the delivery vehicle to provide rendezvous information to the recipient, which rendezvous information can be used by the recipient to find the delivery vehicle and retrieve the parcel, en route, from the driver at a nearby location.

### BACKGROUND OF THE INVENTION

1. Field of Invention

This invention relates to the field of letter and parcel delivery systems, devices and methods. More specifically, the invention relates to a system and method for enabling a recipient to retrieve a parcel after a missed delivery attempt.

2. Description of Related Art

Non United States Postal Service (USPS), letter and parcel delivery systems have been in existence for some time. These letter and parcel delivery system operations typically consist of a corporation which owns and operates a central processing office, smaller satellite offices, delivery vehicles, vehicle drivers, computer systems, GPS tracking systems, fleet management systems, call centers, etc. These private letter and parcel delivery systems came into existence due to the demand for urgent package delivery services: the sender and receiver desire the fastest possible delivery.

The existing systems for sending an urgent parcel for delivery typically consists of the following phases: (a) the sender of a parcel delivers their parcel with an attached label including: the intended parcel recipient (name and address), delivery method, and date, to the parcel delivery company. The parcel delivery company gives each parcel a separate and normally unique tracking number. The parcel is then routed through the company's delivery system towards its intended destination. Note that, the term “parcel”, as used herein, is intended to encompass any parcel, package, letter, envelope, or other item intended to be delivered by a courier service or parcel delivery company, and such terms will be used interchangeably herein.

The parcel is typically first delivered to one of the company's satellite offices, whose delivery vehicles have their own unique local territory. Typically the same delivery vehicle driver is assigned to the same limited geographic area of responsibility each working day, which leads to efficiencies of operation as the driver learns the area and the streets served. For example, a limited geographical area covered by one such delivery vehicle driver could be a 4 mile by 3 mile section of the city, usually with boundaries fixed by roads, rivers, etc.. The delivery vehicle driver will then make a delivery attempt in their limited geographic area to the intended recipient's home or office. If the intended recipient is present at the time of delivery, the package can be signed for, and the urgent package is successfully delivered. If the intended recipient is not present, some parcels of lesser value or importance may be left at the delivery location, pursuant to the package delivery instructions. However, in the absence of the recipient or a designated signatory, other more valuable/important packages requiring a signature cannot be left at the delivery location.

Within existing systems, if the intended recipient or designated signatory is not available to sign for the parcels, the delivery vehicle driver will retain those parcels requiring a signature, returning the parcel to the satellite office until the next day. Thereafter, the driver will make a predetermined number of delivery attempts during the following days. Under existing practices, each time a delivery attempt is made, the delivery vehicle driver is required to leave a written notice of attempted delivery. Such a notice of attempted delivery typically includes the parcel's tracking number, the time/date the delivery was attempted, and notification of whether another delivery attempt will be made the following day. This process literally brings the package to the recipient's doorstep, only to be carried away again, resulting in a great deal of frustration for recipients, which reflects badly on the delivery service. In addition, as the driver will normally reach certain locations at similar times of the day, the driver and recipient may be “scheduled” to miss each other repeatedly, while the urgent parcel is carried all over the surrounding neighborhood for multiple days without arriving in the hands of the intended recipient.

The parcel's tracking number allows for the user (sender of the parcel, intended recipient, or an authorized third party with access to the tracking number) to trace the progress of the parcel online, or to request information regarding the parcel's location from the call center by telephone.

In the existing systems, if all delivery attempts are unsuccessful, typically after the third delivery attempt, the package is returned to the local distribution warehouse, where it normally remains for several additional days. At this point in time, it is the intended recipient's responsibility to travel to the local distribution warehouse to retrieve their parcel. Note that the satellite office and local distribution warehouse are both likely to be located significant distances outside the zone of the individual delivery driver. That is, the small zone previously mentioned (served by a single driver and truck) cannot support an office. Thus, the intended recipient must usually drive a considerable distance to the local office, despite the fact that the truck and package spent the day in the actual neighborhood of the recipient.

If the recipient does not retrieve the package from the warehouse within the specified time period, the parcel is then returned to the sender.

There are several problems and deficiencies with the existing systems. First, if the intended recipient missed the first delivery attempt, the need for urgency has not been met, labor hours have been wasted on the part of the driver, fuel has been wasted to power the truck for the failed initial delivery attempt and repeat attempts, and there is no guarantee that the following day's results will be any different. As noted, if the intended recipient was not home at the initial delivery attempt time, because of rigid work schedules, the recipient may not be available for the future delivery attempts. Furthermore, money has been wasted on the part of the sender, who paid for an urgent delivery service that was not received. Further waste of time, money, and fuel will occur if the third delivery attempt is unsuccessful, because then the intended recipient must drive to the nearest satellite office to retrieve the parcel. By the time this occurs, it will be four or five days after the intended delivery date, causing more of a delay and waste of time, money, and fuel.

One partial remedy to this system is known: if the intended recipient calls the delivery service during the day, it is sometimes possible for the truck driver to divert back to the recipient on the same day but later and thus make the delivery. However, this second attempt is likely to suffer all of the same problems as the first attempt. As such, there is a need for a system that permits the user to retrieve a parcel after an unsuccessful delivery attempt.

Additionally, typically, after three failed delivery attempts, a parcel is stored for several days at a local warehouse, before being returned to the sender, thus causing the delivery service to accrue storage costs, include renting (or buying) a large warehouse and hiring the employees to run it. These warehouses contain hundreds of undelivered parcels, driving up the costs associated both with the space and with the resources for managing the parcels and the space. What is needed is a system that increases the number of successfully delivered parcels, thus reducing storage costs on unsuccessfully delivered parcels.

In view of the above, it is apparent that there exists a need for an improved parcel delivery system, which meets both the sender and intended recipients' need for urgency and cost efficiency.

### SUMMARY OF THE INVENTION

It is accordingly an object of the invention to overcome the above-enumerated inefficiencies, drawbacks and other limitations of existing parcel delivery systems. More particularly, the present invention provides a system and method for greatly improving upon the existing parcel delivery system.

In one particular embodiment of the present invention, a delivery truck, driver and/or parcel is equipped with a position locating system, such as a GPS locating system, a cellular or radio position locating system, or other system. In the present particular embodiment, in the event of a missed delivery, the recipient can contact a service and receive instructions on how to rendezvous with the vehicle and retrieve the parcel, en route, from the driver.

Although the invention is illustrated and described herein as embodied in a parcel retrieval system and method, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWINGS

FIG. 1 is block diagram of one preferred embodiment of the system of the present invention.

FIGS. 2A and 2B are a flow chart of a method in accordance with a first embodiment of the present invention.

FIG. 3 shows an example of a delivery notice in accordance with one particular embodiment of the present invention.

FIG. 4 shows a portion of a flow chart of a method in accordance with a first embodiment of the present invention.

### DESCRIPTION OF THE PREFERRED EMBODIMENTS

The following terms used herein are as defined as follows, however, such definitions shall be exemplary in nature and are not meant to be limiting or to exclude the common and/or common sense meanings for those terms.
“Parcel”—the word parcel includes but is not limited to a parcel, package, letter, envelope, or any other item that is transferred through the mails and by couriers and express delivery companies.
“Intended parcel recipient”—includes but is not limited to the person or business that the sender of the package intends to receive the parcel that the sender of the package sent. This term may also include any individual delegated to, or in charge of, the task of receiving a package on behalf of another, for example, office workers, receiving personnel, gate guards, security officers, receptionists, other designated signatories, agents, and so on.
“Parcel delivery vehicle”—the delivery vehicle or truck that delivers the parcels for the parcel delivery company.
“Processing system” or “processing location”—The processing system of the present invention includes the communications network and other equipment for providing and/or determining the position of a parcel and/or delivery vehicle. Additionally, the processing system can include the equipment and/or personnel that use the determined position information to provide the intended recipient with the information with which to rendezvous with the delivery vehicle, such as street address of the vehicle, or the street address of an appointed rendezvous location. Such processing location could be implemented as a central processing station (i.e., nationally) or as a plurality of local processing stations (located in a plurality of geographic locations, each serving a subset of delivery vehicles) and/or a call center in communication with one or more processing locations.
“Communications network”—The communications network of the instant invention can include any equipment used to provide the central processing system with the position of the delivery vehicle and/or parcel, or the information from which to derive the location. For example, the communications network can include one or more of: a system of telephone landlines, a satellite communication system, a cellular telephone network a radio communications network, etc.. The communications network links to the central processing system to provide the central processing system with the location of the delivery vehicles/parcels and/or information from which the location can be derived.
“Position locating equipment”—Although the present preferred embodiments primarily discuss the use of Global Positioning Satellite System receivers to determine the position of a delivery vehicle, the invention is not meant to be so limited. Rather, it is understood that other known position locating systems can be used in place of, or in connection with, GPS systems. For example, there are a variety of known position triangulation systems that could be used with the present invention, including, cellular triangulation system, other radio and/or satellite network triangulation systems, and other position locating systems, any of which can be used in connection with the present invention. Additionally, note that, when stating herein that the position locating/indicating/reporting equipment reports the current location of the delivery vehicle, it is intended that such a device can be carried by the delivery vehicle, the parcel or even the delivery driver, any of which can be used to determine the current location of the delivery vehicle or delivery driver and hence, the parcel. For purposes of the instant application, the delivery vehicle is defined as including a position indicating device if the device is predominantly located on or within the delivery vehicle. For example, it is intended that, for purposes of the present invention, if the delivery driver carries a GPS enabled (or other position indicating) handheld mobile computer device that can periodically report position information to a remote location, that device is sending “location” or “position” information “of the delivery vehicle”, even when the driver is outside the vehicle, the presumption, being that the driver is still near or local to the delivery vehicle.
“Telephone” or “phone”—The term “telephone” or “phone” is intended to include, but not be limited to, a standard home telephone, an office telephone, a cellular telephone or mobile telephone, a satellite phone, a Voice Over Internet Protocol (“VOIP”) telephone, a smartphone and/or a combined PDA phone.

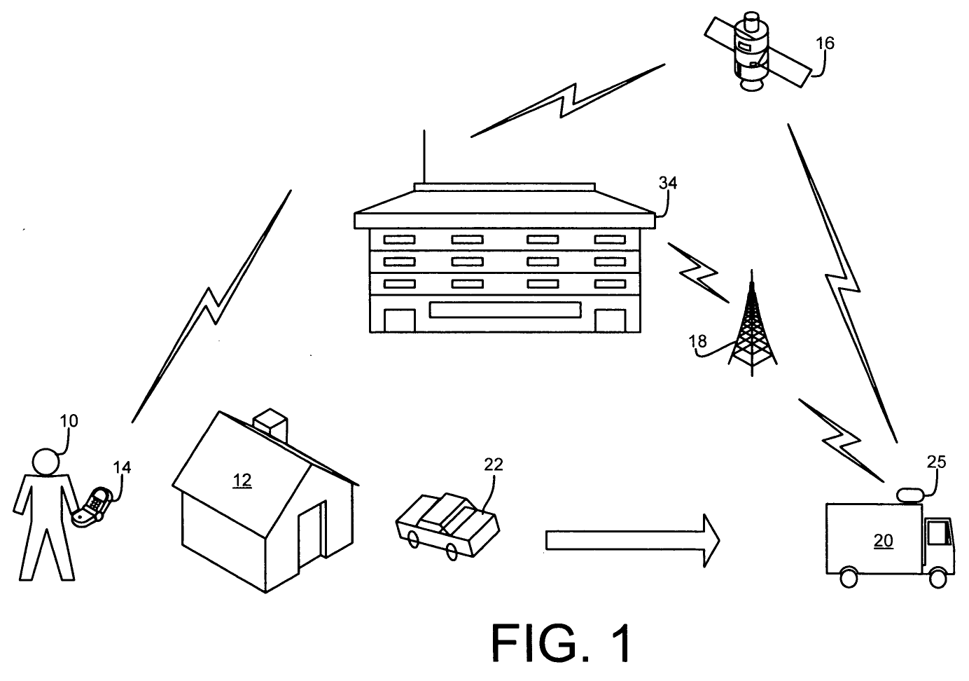

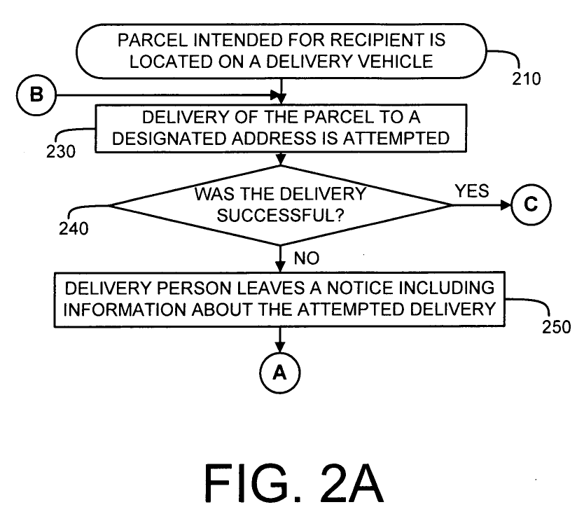

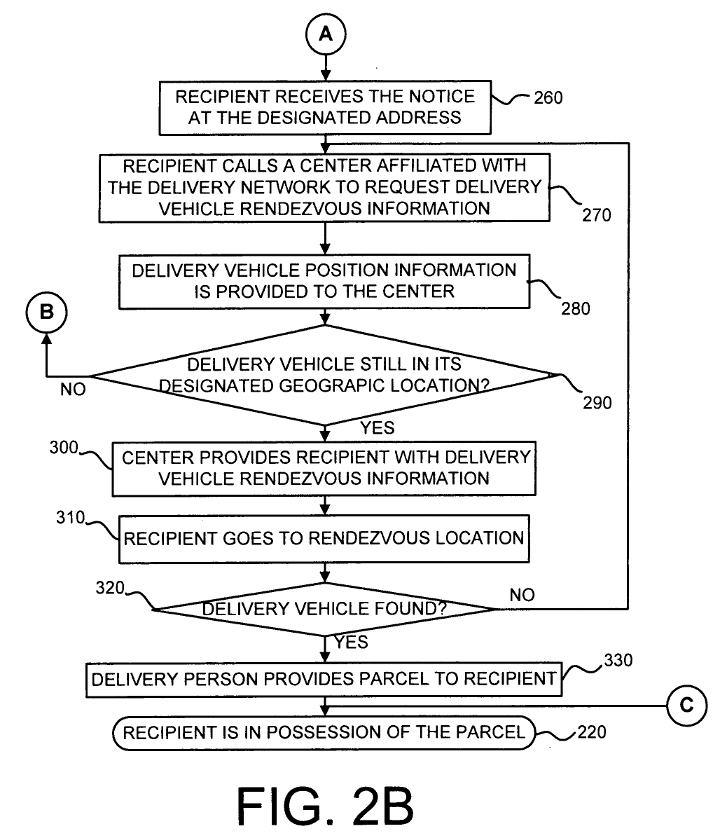

Referring now to FIGS. 1 and 2, there is shown one particular embodiment of a system and method for implementing the instant invention. A parcel intended for a particular recipient 10 at a designated address is loaded into a delivery vehicle 20. Step 210 of FIG. 2. Typically, a particular delivery vehicle 20 will be assigned to a particular limited geographic area, such that the same delivery vehicle 20 will service the same limited geographic area recurrently. Alternately, a unique route can be created for the delivery vehicle 20 each day, depending on the deliveries to be made during that day. Such a route can be programmed daily into a travel computer located in the vehicle, which guides the driver along the unique route. A parcel to be delivered will be loaded onto a particular delivery vehicle 20 if the parcel's designated delivery address 12 is in the limited geographic area or specific route serviced by that delivery vehicle 20.

The parcel delivery vehicles, delivery drivers and/or the parcels themselves, can be provided with the appropriate devices for remotely determining the position of such vehicles and/or parcels. For example, each delivery vehicle 20, or the driver thereof, can be provided with a communication device 25 to assist in tracking the location of the delivery vehicle 20. In one particular embodiment of the invention, each delivery vehicle (i.e., and/or driver and/or parcel) can be provided with a GPS (Global Positioning Satellite) and/or other satellite position locator (such as, the QUALCOMM Automatic Satellite Position Reporting (QASPR) system) and a wireless communication device that provides the location of the delivery vehicle 20 (i.e., including the current street address of the vehicle) to a local or central processing location 30. Alternately, each delivery vehicle 20, parcel and/or driver can be provided with communications equipment that would permit the particular location of the delivery vehicle to be determined, using known terrestrial radio and/or cellular triangulation systems. For purposes of example only, each delivery vehicle 20 could be provided with a communications device 25, such as the OmniTRACS Fleet tracking system by QUALCOMM. Among other features, the OmniTRACS system includes automatic satellite vehicle positioning using either QASPR or GPS, and two-way text and data communications.

During operation, the delivery vehicle 20 containing the parcel intended for the recipient 10 follows a delivery route. While traveling along the route, the communications device 25 of the delivery vehicle can be providing location information to a local or central processing location, such that the position of the delivery vehicle 20 can be determined and/or tracked. Upon reaching the designated address 12, the driver/delivery person of the delivery vehicle 20 gathers the parcel and exits the vehicle. If the parcel requires a signature in order to be left, the driver knocks on the door or rings the bell at the designated address 12, or otherwise tries to make contact with the recipient or recipient's agent (collectively, the “recipient”). If a recipient is present at the address and signs for the parcel, the driver leaves the parcel with the recipient. Steps 220 and 240 of FIG. 2. Similarly, if the parcel does not require signature, the driver can leave the parcel with a recipient or on the threshold of the designated address. However, if the parcel requires a signature and the delivery person does not make contact with a recipient authorized to sign for the parcel, the delivery person normally returns the parcel to the truck, leaving behind a written notice or other written indicia informing the recipient of the details regarding the delivery attempt. Steps 240 and 250 of FIG. 2.

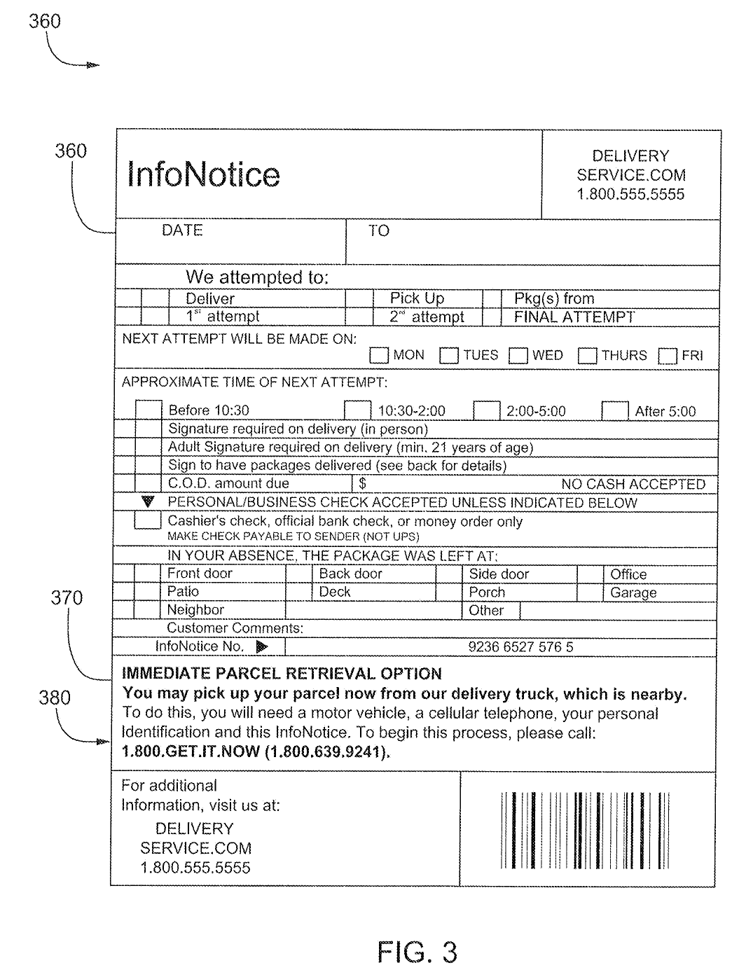

Upon receiving and reviewing the written delivery notice left at the designated address (Step 260), the recipient will be informed by the notice that it may still be possible to rendezvous with the driver and to receive the parcel. For example, referring now to FIG. 3, there is shown one particular embodiment of a delivery notice 350 that can be used with the instant invention, although it should be understood that other forms of notice could be used. Delivery notice 350 includes a general information portion 360 and a retrieval information portion 370 relating to how the recipient can effectuate early retrieval of the parcel. In the example of FIG. 3, retrieval information portion 370 informs the recipient on how to immediately retrieve the parcel, in the event that the delivery vehicle is still located nearby.

In the particular example of FIG. 3, retrieval information portion 370 provides a telephone number 380 for use by the recipient in determining a location at which to rendezvous with the delivery vehicle and retrieve the package. Optionally, to ensure complete mobility, the retrieval information portion 370 can additionally provide further instructions.

In one particular embodiment of the present invention, the retrieval information portion 370 of the delivery notice 350 informs the recipient that, in order to optimally participate in the service, a motor vehicle, mobile telephone, personal identification and the notice are required. However, this is not meant to limiting, as any or all of these items can be omitted and the invention can still be performed. For example, the use of a mobile telephone permits the user to call the telephone number 380 again from the road, if the delivery vehicle is not found at the rendezvous location. However, as can be seen, the use of a wired, landline telephone, instead of a cellular or mobile telephone, would not, automatically, disqualify the recipient from participation in the immediate retrieval program of the instant invention.

Referring back FIGS. 1 and 2, once the recipient has received the notice (step 260 of FIG. 2), the recipient wanting to immediately retrieve the parcel calls the telephone number (380 of FIG. 3) given on the delivery notice. Step 270 of FIG. 2. As stated herein, the recipient can call from any type of telephone, including a wired, wireless, cellular, radio, mobile, satellite and/or VOIP telephone, and still be within the scope of the instant invention. Upon calling the telephone number (380 of FIG. 3) given on the delivery notice (350 of FIG. 3), the recipient is connected with an information provider 34 affiliated with the delivery program. For example, the recipient can be connected with a central processing location, one of a plurality of local processing locations and/or a call center, affiliated with the delivery service. Once connected by telephone, the processing center or call center requests the parcel tracking number or delivery notice number from the delivery notice. In response to entry of the parcel tracking number or delivery notice number (or some other number providing identification of the parcel, the processing system/call center provides the intended recipient with a location with which to rendezvous with the parcel delivery vehicle that contains the parcel. For example, the processing system/call center may provide the recipient with the current street address of the delivery vehicle as the intended rendezvous location. Alternately, if the processing system/call center is pre-informed of that day's delivery route and/or schedule followed by the driver, the processing system/call center could provide the recipient with the next (and/or other future) address to be visited by the driver. By using a future location as the rendezvous location, the system provides for a certain amount of travel time of the recipient. Note that, in either case, one unique feature of the instant invention is that the rendezvous location is determined in real-time, in response to a request by the recipient.

Optimally, the recipient's call to the processing system/call center 34 will be automated (i.e., using an interactive voice response system (IVR) or an automated voice response system (AVR)). For example, once connected by telephone or recipient's communication device 14, a prerecorded or synthesized voice will audibly request the recipient to enter or say the parcel number or delivery notice number. Hearing this over the speaker portion of the telephone 14, the recipient can enter the requested number on the telephone keypad or, if an interactive voice response (IVR) system is used, the recipient can say the requested number. In response, the automated processing system/call center information system can audibly provide the recipient with the rendezvous location using a synthesized voice. However, if desired, a call center attendant or other human operator could be available to speak with the recipient.

Note that, in the most preferred embodiment, the user will interact with the processing system/call center 34 through audible voice communications, and not by contact with the processing system/call center 34 through any browser or other visual computer interaction. The advantage to an audible system is that it can be provided to anyone having a telephone, without the need for a computer or the need for starting a computer, in order to locate the delivery vehicle and parcel. Thus, such a system is fast (not having the delays of waiting for a computer to boot up), portable and inclusive to all.

However, if desired, it can be seen that an embodiment of the instant invention could be made wherein a user of a mobile smartphone or PDA phone could communicate with the processing system/call center using an internet browser or other visual interface. For example, the recipient could communicate with the center via an internet website for the center, if desired. In such a system, in response to keying in and transmitting the parcel identification number, the recipient will be provided with a textual or visual location and/or map showing the rendezvous location and/or the route of the delivery vehicle 20. Additionally, if desired, the communications device 14 of the recipient 10 can be a radio-frequency equipped computing device, which communicates with the processing station/call center 34 via a radio-frequency data network.

Once the recipient has requested delivery vehicle rendezvous information (step 270 of FIG. 2), the processing location/call center 34 must obtain the current location of the delivery vehicle 20 containing the package identified by the requested number. The location information of the delivery vehicle 20 is provided electronically to the processing location/call center 34 over a communications network which could include one or more of a satellite communications device 16, cellular tower 18, telephonic landlines and/or other communications networks. Step 280 of FIG. 2B The location of the vehicle is ascertained through known location positioning systems, for example, GPS or other satellite positioning systems (which may utilize the satellite 16 of FIG. 1), cellular and/or radio triangulation utilizing a plurality of cellular or radio antennas 18, and/or other position locating systems. Note that, it is possible for positioning to be determined using a satellite system 16 (i.e., GPS or QASR), while bidirectional communication from the delivery vehicle 20 to the processing station 34 could be effected using cellular or radio telephony via towers 18, or vice versa (i.e., positioning using radio/cell towers 18 and bidirectional communication via satellite 16). Alternately, positioning and communications can be performed using the same type of system of communication 16 or 18, as is the case with the OmniTRAC system by QUALCOMM. In one particular embodiment of the invention, the delivery vehicle 20 includes a GPS position determining device and the GPS determined location of the vehicle is transmitted to the processing location 34 by at least one of satellite 16 or cellular/radio tower antenna 18.

Information including the current vehicle location and/or information from which the current vehicle location can be determined is transmitted by the delivery vehicle 20, using communications device 25, to a processing location 34. The processing location uses the information to provide a rendezvous location to the requesting recipient. Note that, location information from the delivery vehicle 20 can be provided to the processing location in real-time (i.e., continuously or repeatedly throughout the work day, rather than in response to a customer query), or in response to a specific poll from the processing location, generated in response to the request from the recipient 10, as desired. Additionally, if desired, the information about the location of a delivery vehicle can be determined at a processing location, but provided to a call center 34 located remotely from the processing location. For example, real-time location data can be determined by a processing location and maintained in a database accessible from a call center.

From the delivery vehicle position information provided to the processing location/call center 34, the processing location/call center 34 can determine whether the delivery vehicle 10 is still located within its designated limited geographic area (step 290 of FIG. 2) and/or is still located near the recipient. If the delivery vehicle is no longer located in the limited geographic area, or is no longer nearby the designated address 12 of the recipient 10, the recipient is informed of this information and told that delivery of the parcel will be attempted again. (Steps 290 and 230 of FIG. 2).

However, if the delivery vehicle 20 is still located in its designated limited geographic area and/or still making deliveries local to the designated address 12, the call center IVR system (or operator) responds by providing a rendezvous location to the caller. Step 300 of FIG. 2. If desired, the call center IVR system (or operator) could also provide the recipient with driving directions or nearby landmarks, as well, (i.e. “two blocks east of the Fatway Grocery Store on Elm Street”). In one particular embodiment of the present invention, the IVR system could additionally advise the caller to bring along a mobile or cellular phone, in case the delivery vehicle is not found at the last given rendezvous location.

Once provided with the rendezvous information, the recipient 10 can walk (if the rendezvous location is close) or drive in the recipient's vehicle 22 to the rendezvous location. Step 310 of FIG. 2. If the delivery vehicle 20 is not found at the last provided rendezvous location, the recipient 10 can call the processing location/call center 34, again, for updated delivery vehicle rendezvous information. Steps 320 and 270-310 of FIG. 2. If the recipient catches the truck at or near the rendezvous location, the recipient can retrieve the parcel from the delivery person, resulting in the recipient being in possession of the parcel. Steps 330 and 220 of FIG. 2. In one particular embodiment of the present invention, the recipient presents the delivery notice (received in step 260) to the delivery person, along with personal identification, in order to collect the parcel. As stated above, FIG. 3 is one possible example of a delivery notice 350 to be delivered to a recipient if the traditional delivery attempt fails. The general information portion 360 of the notice 350 illustrates a standard attempted delivery notice, while the retrieval information portion 370 is unique to the system of the present invention.

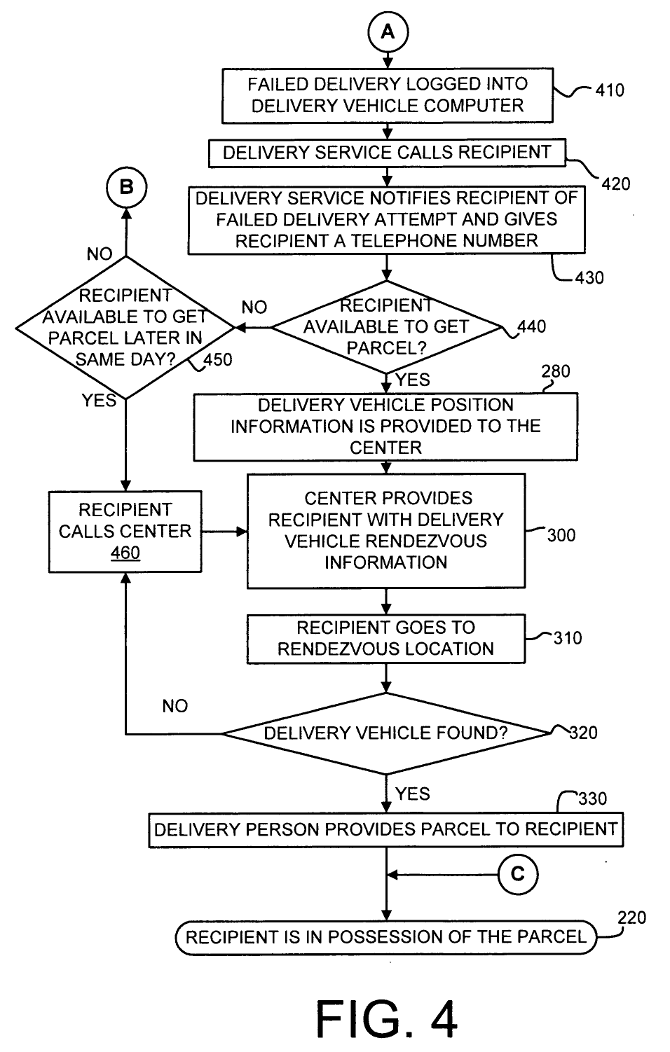

Referring now to FIG. 4, there is shown a flow diagram 400 of another embodiment of the instant invention, wherein, instead of, or in addition to, a delivery notice (350 of FIG. 3) being left at the designated delivery address, the intended recipient is notified of the unsuccessful delivery of the parcel by the delivery service. For example, the delivery person/driver can log the failed delivery into a delivery system computer in the delivery vehicle 20, which delivers the information to the processing location/call center 34 via the communications device 25. Step 410 of FIG. 4. In response to receipt of the failed delivery attempt notification, the processing location/call center 34 can call the recipient, to inform the recipient of the failed delivery attempt and the chance for immediate parcel retrieval. Step 420 of FIG. 4. Such a call can be made if the recipient's telephone number is on file with the call center 34. Typically, when filling out a label including the designated delivery address, the telephone contact number for the recipient is requested. This telephone contact number can be entered and stored in the delivery system database, in the same manner in which the designated delivery address is entered and stored. Such notification can be performed by an IVR and/or AVR system or by a human operator, as described elsewhere herein.

In response to notification of a failed delivery attempt, the system of invention can call the recipient, using the telephone contact information associated with the parcel, give the recipient information about the failed delivery attempt and the telephone number of the center (step 430 of FIG. 4) and ask the recipient if they are able to proceed to a rendezvous location and retrieve the parcel. Step 440 of FIG. 4. If the recipient indicates that they are in a position to do so, the recipient says “yes” or enters a responsive keystroke on the telephone keypad. Otherwise, the user says “no” or enters a keystroke indicating the negative on the telephone keypad. If the recipient responded “no”, the system could inform the user that it may be possible to rendezvous later with the delivery vehicle, and to call the previously given telephone number to try. If the recipient is available later (step 450 of FIG. 4), the recipient can call the center to receive a current rendezvous location for the delivery vehicle. Step 460 of FIG. 4.

If the recipient answered “yes” initially to the question of availability, the system would provide the recipient with a current rendezvous location. Step 300. If the delivery vehicle is no longer at the given rendezvous location, the user can call the previously given telephone number to receive an updated rendezvous location. Step 460 of FIG. 4.

The remaining steps of the method 400 are the same as described above in connection with FIGS. 2A and 2B. Additionally, FIG. 2A provides the first steps of FIG. 4 (As shown by connector “A” in both of those figures).

The invention illustrated herein provides a parcel recipient with the choice of immediately retrieving the parcel from the delivery vehicle at a provided rendezvous location, or of waiting for the next delivery attempt. The retrieval system and method of the present invention will improve upon the existing parcel delivery system in the following ways:
(a) When the intended recipient receives a notice of attempted delivery, the intended recipient will now have an option to retrieve their package immediately.

This is done by the intended recipient calling the phone number on the notice and then entering the tracking number through the phone into the central processing system. The initial call can be made from any phone, but the user is encouraged to bring their cellular telephone with them to call the number again, in case the delivery truck has moved to another location. The central processing system, using the tracking number, will then respond to the user with the package delivery truck's current location, which may change in a short period of time. This will allow the user to immediately drive to the parcel delivery truck's location in order to immediately retrieve their package. Since the parcel delivery vehicle is always within the same limited geographical area, the parcel delivery vehicle will always be within a few blocks of the intended recipient's home or business, allowing the intended recipient to drive to the parcel delivery vehicle's current location, even if the delivery truck moves during the time the user is attempting to make the rendezvous. Since the driver will of necessity have to pause at each stop, and since the geographical distances in one truck route are designed to be quite compact, the recipient/user can “catch up” with the truck without undue chase.
(b) Efficiency will be increased in several ways, including the following, among others. First, the present invention will achieve the primary goal of urgency, by enabling the intended recipient to receive their package as soon as possible, whether the recipient was at the delivery location or not. Second it will result in significant environmental and fuel cost savings to the parcel delivery company. This is accomplished by eliminating the need for repeated failed delivery attempts. Third, it will result in significantly reduced labor costs, by reducing the number of labor hours required for repeated delivery attempts. Fourth, it will result in significantly reduced paper supply costs, by reducing the need to leave written notifications of failed delivery attempts.

It will be appreciated that for reasons of efficiency and accountability, most modern delivery vehicles are, in fact, already equipped with GPS position locating systems. These are used to assess driver discipline and speed, however, and have not previously been used for the method of the invention.

One main goal behind the retrieval system and method of the present invention is to further accomplish the main objectives of the package delivery systems. The retrieval system and method are designed to be employed by a parcel delivery company whose primary objectives in the package delivery business are to meet the demand for the consumers' urgency of delivering the parcel as inexpensively and as efficiently as possible. The present retrieval system and method uniquely improves upon the above objectives, in that it would transfer part of the expense of delivery from the delivery company to the intended package recipient, if the intended package recipient so chooses. Any potential added costs borne by the parcel recipient, which would, typically, be less than a dollar in fuel costs, and normally less than 20 minutes of the intended recipient's time, would be happily accepted by the intended recipient in order to ensure timely receipt of the parcel. Additionally, the added 50 cents to a dollar worth of time and fuel, multiplied by the thousands of potential customers, would result in serious enterprise wide savings of fuel, time, money, and overall expenses for the delivery carrier, not to mention the time and fuel saved by the carrier in avoiding multiple, unsuccessful future delivery attempts. Additionally, typically, after three failed delivery attempts, a parcel is stored for several days at a local warehouse, before being returned to the sender, thus causing the delivery service to accrue storage costs, include renting (or buying) a large warehouse and hiring the employees to run it. These warehouses contain hundreds of undelivered parcels. By increasing the percentage of successfully delivered parcels, the number of parcels going to the warehouse will decrease, resulting in additional savings for the carrier. Thus, it can be seen from the foregoing, that the instant invention provides an overwhelming savings in fuel and time/man hour expenses to the delivery service.

### Index of the Item Numbers:

| | |
|---|---|
| Particular Recipient | 10 |
| Location Of Attempted Delivery | 12 |
| Recipient Communication Device | 14 |
| Recipient's Vehicle | 22 |
| Delivery Vehicle and/or Delivery Person | 20 |
| Delivery Vehicle Communication Device | 25 |
| Satellite | 16 |
| Cellular Tower | 18 |
| Processing Location/Call Center | 34 |
| Notice | 350 |
| General Information Portion | 360 |
| Retrieval Information Portion 77 | 370 |
| Telephone Number | 380 |

The disclosure is provided to allow practice of the invention (after the expiration of any patent granted hereon) by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention.

I claim:

1. A method for facilitating the retrieval of a parcel by a recipient, the system comprising:
placing a parcel to be delivered on a delivery vehicle;
communicating information about the location of the parcel delivery vehicle to a remote location;
determining a rendezvous location from the information about the location of the parcel delivery vehicle;
providing information about the rendezvous location to the recipient; and
providing the parcel to the recipient at the rendezvous location.

2. The method of claim 1, wherein the rendezvous location is the current location of the parcel delivery vehicle.

3. The method of claim 1, wherein the rendezvous location is a predicted future location of the parcel delivery vehicle.

4. The method of claim 1, further including the steps of:
attempting delivery of said parcel to a location identified on said parcel; and
leaving a notice at the location identified on the parcel, if the delivery attempt is unsuccessful, said notice including instructions to the recipient on how to obtain the rendezvous location.

5. The method of claim 1, wherein the determining step is initiated by a query from the recipient.

6. The method of claim 1, wherein the information about the location of the parcel delivery vehicle is communicated to the remote location over a first communications network and the recipient is provided the rendezvous location over a second communications network.

7. The method of claim 6, wherein the first communications network is different from the second communications network.

8. The method of claim 7, wherein the first communications network is a satellite network and the second communications network is a telephone network.

9. The method of claim 6, wherein the first communications network and the second communications network are parts of the same network

10. The method of claim 9, wherein the network is a telephone network.

11. A system for facilitating the retrieval of a parcel by a recipient having access to a first communications device, the system comprising:
a parcel delivery vehicle containing the parcel, said parcel delivery vehicle including a position communicating device, said position communicating device communicating information about the location of said parcel delivery vehicle to a remote location;
a processing location accessing position information of said parcel delivery vehicle, said position information being derived from said information about the location of said parcel delivery vehicle, said accessed position information being used at said processing location to determine a rendezvous location;
said processing location including at least a second communications device for communicating with the first communications device accessed by the recipient; and
said processing location providing information about said rendezvous location to the recipient via the second communications device.

12. The system of claim 11, wherein said processing location includes:
a first location receiving said information about the location of said parcel delivery vehicle and determining at least one of a current position of said parcel delivery vehicle and said rendezvous location; and
a second location, remote from said first location, but in communication with said first location, said second location in communication with the recipient to provide information about said rendezvous location to the recipient.

13. The system of claim 11, wherein said rendezvous location is a current location of said parcel delivery vehicle.

14. The system of claim 11, wherein said rendezvous location is a predicted future location of said parcel delivery vehicle.

15. The system of claim 11, further including a notice providing instructions to the recipient on how to obtain said rendezvous location, said notice being left at an intended delivery address indicated by the parcel, in the event of an unsuccessful delivery attempt.

16. The system of claim 11, wherein the connection between said first communications device and said second communications device is initiated by the recipient.

17. The system of claim 11, wherein said information about the location of the parcel delivery vehicle is communicated to the remote location over a first communications network and the connection between said first communications device and said second communications device is made over a second communications network, said second communications network being of the same type as said first communications network.

18. The system of claim 17, wherein said first communications network is a telephone network.

19. The system of claim 11, wherein said information about the location of the parcel delivery vehicle is communicated to the remote location over a first communications network and the connection between said first communications device and said second communications device is made over a second communications network, said second communications network being of a different type than said first communications network.

20. The system of claim 19, wherein said first communications network is a satellite network and said second communications network is a telephone network.

21. The system of claim 11, wherein said processing location includes an automated device to provide said information about said rendezvous location to the recipient via the second communications device.

22. The system of claim 21, wherein said automated device includes at least one of an interactive voice response (IVR) system and an automatic voice response (AVR) system

23. The system of claim 15, where the notice includes at least a telephone number to call in order to receive the rendezvous location and a tracking number associated with the undelivered parcel.

24. A method for facilitating the retrieval of a parcel by a recipient, the system comprising:
placing a parcel to be delivered on a delivery vehicle;
attempting delivery of the parcel at an address associated with the parcel;
leaving a notice at the location associated with the parcel, if the delivery attempt is unsuccessful, the notice including instructions to the recipient on how to obtain the rendezvous location
communicating information about the current location of the parcel delivery vehicle to a remote location;
determining, in real-time, a rendezvous location from the information about the current location of the parcel delivery vehicle in response to a request by the recipient;
providing information about the rendezvous location to the recipient; and
providing the parcel to the recipient at the rendezvous location.

25. The method of claim 24, wherein the rendezvous location is the current location of the parcel delivery vehicle.

26. The method of claim 24, wherein the rendezvous location determined in the determining step is a predicted future location of the parcel delivery vehicle.

27. The method of claim 24, wherein the information about the rendezvous location to the recipient is provided in the providing step by an automated device.
